(19) United States
(12) Patent Application Publication
(10) Pub. No.: US 2022/0101368 A1
(43) Pub. Date: Mar. 31, 2022

(54) PREFERENTIAL TREATMENT INFORMATION MANAGEMENT DEVICE AND CONTROL PROGRAM

(71) Applicant: TOSHIBA TEC KABUSHIKI KAISHA, Tokyo (JP)

(72) Inventor: Keigo SHIBATA, Tagata Shizuoka (JP)

(21) Appl. No.: 17/475,868

(22) Filed: Sep. 15, 2021

(30) Foreign Application Priority Data
Sep. 25, 2020 (JP) 2020-160727

(51) Int. Cl. G06Q 30/02

(52) U.S. Cl. CPC G06Q 30/0235; G06Q 30/0239; G06Q 30/0212; G06Q 30/0211

(57) ABSTRACT

According to one or more embodiments, a preferential treatment information management device includes a storage device and a processor. The storage device stores preferential treatment information provided to a consumer terminal. The preferential treatment information includes a period of use during which a store visit is being promoted. The processor acquires a number of store-entering people of a current day that falls within the period of use of the preferential treatment information. The processor update the preferential treatment information according to the acquired number of store-entering people of the current day for further promotion of the store visit.

### CROSS-REFERENCE TO RELATED APPLICATION

This application is based upon and claims the benefit of priority from Japanese Patent Application No. 2020-160727, filed Sep. 25, 2020, the entire contents of which are incorporated herein by reference.

### FIELD

Embodiments described herein relate generally to a preferential treatment information management device and a control program therefor.

### BACKGROUND

In order to level the number of visitors over stores hours at a retail store, there has been a system for predicting a time period or a time zone when there are less visitors and distributing to consumers coupons that can be used or have higher rates in the predicted time period to attract more visitors during the less busy period.

However, mere distribution of such coupons is not necessarily considered attractive preferential treatment for many of the consumers, and a more effective approach is sought to further the leveling of the number of visitors. Also, in recent years, there has been an increasing request to avoid crowding or a risk of overcrowding inside a store from the viewpoint of infectious disease prevention, and further improvement of the leveling of the number of store visitors has been desired.

Hence, there is a need for a device capable of managing preferential treatment information for leveling the number of visitors at a retail store or the like in a further effective way.

### DESCRIPTION OF THE DRAWINGS

FIG. 1 is a schematic diagram of an example configuration of a system including a preferential treatment information management device according to an embodiment.

FIG. 2 is a schematic diagram of an example data structure of a member record according to an embodiment.

FIG. 3 is a schematic diagram of an example data structure of a number-of-customers memory according to an embodiment.

FIG. 4 is a schematic diagram of an example data structure of a current-day memory according to an embodiment.

FIG. 5 is a block diagram of an example circuit configuration of a coupon server according to an embodiment.

FIG. 6 is a schematic diagram of an example data structure of a coupon data record according to an embodiment.

FIG. 7 is a schematic diagram of an example configuration of a prediction table according to an embodiment.

FIG. 8 is a schematic diagram of an example configuration of a current-day table according to an embodiment.

FIG. 9 is a flowchart of information processing executed by a coupon server according to a coupon issuing program according to an embodiment.

FIG. 10 is a flowchart of information processing executed by a coupon server according to a coupon updating program according to an embodiment.

FIG. 11 is a diagram of an example coupon image according to an embodiment.

FIG. 12 is a diagram of an example updated coupon image according to an embodiment.

### DETAILED DESCRIPTION

According to one embodiment, a preferential treatment information management device includes a storage device storing preferential treatment information previously provided to a consumer terminal. The preferential information includes a period of use during which a visit to a store is being promoted, a predicted store crowding level for the period of use, and a coupon set based on the predicted store crowding level. A processor is configured to acquire the number of people entering the store on a current day that falls within the period of use, and then potentially update the coupon in the stored preferential treatment information according to the acquired number of people entering the store.

Some example embodiments will be explained below with reference to the accompanying drawings. These embodiments relate to a preferential treatment information management device (or a preferential-treatment-information management device) that manages, as one example of preferential treatment information, information of an electronic coupon that has a preset period of coupon use. The electronic coupon may be, for example, an electronic ticket that can be downloaded to a consumer terminal, such as a smartphone owned or carried by a consumer, a customer, or the like, and is used for a discount or the like for shopping at a target retail store.

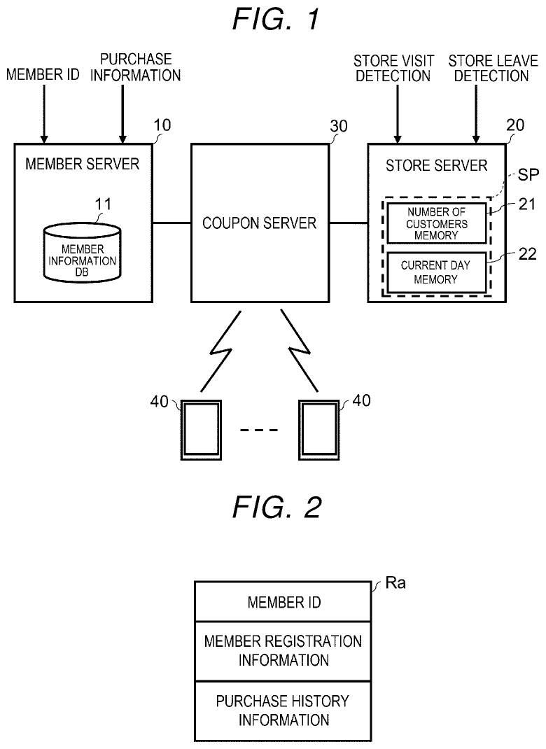

FIG. 1 is a schematic diagram of an example configuration of a system including the preferential treatment management device according to one embodiment. The system includes a member server 10, a store server 20, and a coupon server 30. The system may further include other servers. Alternatively, one server may include functions of two or more servers. The servers are connected to one another by an inter-server network and configured to transmit and receive data signals among the servers.

The coupon server 30 is a computer device functioning as the preferential treatment information management device and enables wireless communication with a terminal (may also be referred to as a consumer terminal) 40 of a consumer, to which preferential treatment information will be provided. The terminal 40 is, for example, a portable communication terminal. Examples of the terminal 40 include, but are not limited to, a smartphone, a tablet terminal, and a notebook personal computer.

In one instance, to use the present system, a consumer may first install an application program exclusive for the system in the terminal 40 and perform member registration. This enables the consumer to receive the preferential treatment information, such as an electronic coupon, managed by the coupon server 30. The application program exclusive for the system is referred to as a “coupon application.” A consumer who has completed the member registration is referred to as a “member.” A consumer may be referred to as a “customer” as well. The term “customer” includes, in general, not only a member but also a non-member consumer.

The member server 10 is a computer device for managing information concerning members. The member server 10 includes a member information database (DB) 11. The member information database 11 is an aggregate of member records Ra (see FIG. 2) created for the respective members. The member information database 11 is saved in, for example, an auxiliary storage device included in the member server 10. Examples of the auxiliary storage device include, but are not limited to, a Solid-State Drive (SSD), a Hard Disc Drive (HDD), and an Electrically Erasable Programmable Read-Only memory (EEPROM).

FIG. 2 is a schematic diagram of an example data structure of one member record Ra. The member record Ra includes a member ID, member registration information, and purchase history information. The member ID is a unique code set for each of the registered members as a member identifier. The member ID is set in the terminal 40 of the member identified by the member ID. Alternatively, the member ID is correlated with a terminal ID of the terminal 40 of the member identified by the member ID and is set in the member server 10. The terminal ID is identification information of the terminal 40.

The member registration information is information registered by the member during the member registration process. The member registration information includes personal information such as an address, a name, age, and sex. The member registration information may include information based on a questionnaire such as a favorite commodity and a frequently used store.

The purchase history information is cumulative data of purchase information, that is information concerning commodities purchased by the registered member in the past. The purchase information is provided to the member server 10 from, for example, a Point Of Sales (POS) system of a store together with the member ID. Upon receipt of the purchase information, the member server 10 adds the received purchase information to the purchase history information in the member record Ra that includes the corresponding member ID.

The store server 20 is a computer device for managing information relating to a target store, that is a store where the electronic coupon as the preferential treatment information managed by the coupon server 30 can be used. The store server 20 includes a number-of-customers memory 21 and a current-day memory 22. If there are a plurality of stores where the electronic coupon can be used, the number-of-customers memory 21 and the current-day memory 22 are provided for each of such stores SP. The number-of-customers memory 21 and the current-day memory 22 are saved in, for example, an auxiliary storage device included in the store server 20. The auxiliary storage device may be an SSD, a HDD, an EEPROM, or the like.

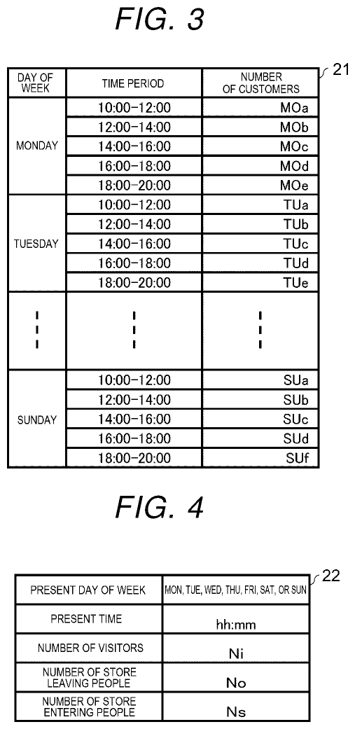

FIG. 3 is a schematic diagram of an example data structure of the number-of-customers memory 21. As illustrated in FIG. 3, the number-of-customers memory 21 forms areas, each of which stores a number of customers during each of designated time periods (or time zones) MOa, MOb, . . . and SUf in each of days of week from Monday to Sunday. The number of customers of each of the time periods MOa, Mob, . . . and SUf is a number of customers who visited the store during the corresponding time period in the past. As one example, the number of customers of each of the time periods MOa, MOb, . . . and SUf on each day of week may be an average number of customers who visited the store during the corresponding time period on the corresponding day of week in the past year. In the example of FIG. 3, the designated time periods are in the span of ten hours from 10:00 to 20:00 in units of two hours. The time periods are not limited to this example and may be in units of one hour or in units of three or more hours. The interval of the time periods may not necessarily be fixed. If there are a plurality of stores where the electronic coupon can be used, the interval of the time periods may be common to all the stores or different among the stores.

FIG. 4 is a schematic diagram of an example data structure of the current-day memory 22. As illustrated in FIG. 4, the current-day memory 22 forms areas for respectively storing a present day of week, present time, a number of visitors Ni, a number of store-leaving people No, and a number of store-entering people Ns. A day of week of a current day is described in the area of the present day of week. Time at a present point in time is described in the area of the present time. The number of customers who visited the target store up until the present time of the current day is described in the area of the number of visitors Ni. The number of customers who left the store up until the present time of the current day is described in the area of the number of store-leaving people No. The number of people obtained by subtracting the number of store-leaving people No from the number of visitors Ni at the present point in time is described in the area of the number of store-entering people Ns.

The store server 20 is also provided with store-visit-detection information and store-leave-detection information from a device or an apparatus, such as a sensor, installed at the store. For example, the store-visit-detection information indicates a number of times the sensor detects customers visiting the store. The store-leave-detection information indicates a number of times the sensor detects customers leaving the store. The sensor may be an image sensor device that detects the store-visiting people (or visitors) and store-leaving people based on an image captured by a camera. In another example, the sensor may be an optical sensor, a weight sensor, or the like that detects a person passing through an entrance of the store.

The store server 20 calculates, based on the store-visit-detection information, the number of customers who visited the store during each of the designated time periods in each of the days of week. The store server 20 then updates the number of customers in each corresponding area (MOa, MOb, . . . and SUf) of the number-of-customers memory 21. Also, the store server 20 counts the number of visitors Ni based on the store-visit-detection information and stores it in the corresponding area of the current-day memory 22. The store server 20 further counts the number of store-leaving people No based on the store-leave-detection information and stores it in the corresponding area of the current-day memory 22. Lastly, the store server 20 updates the number of store-entering people Ns in the corresponding area of the current-day memory 22 to a number obtained by subtracting the number of store-leaving people No from the number of visitors Ni.

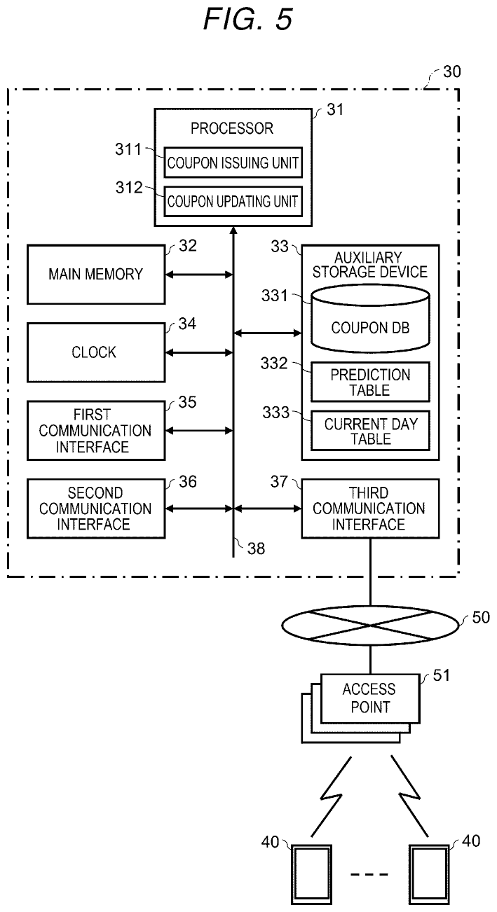

FIG. 5 is a block diagram of an example circuit configuration of the coupon server 30. The coupon server 30 includes a processor 31, a main memory 32, an auxiliary storage device 33, a clock 34, a first communication interface 35, a second communication interface 36, and a third communication interface 37. The processor 31, the main memory 32, the auxiliary storage device 33, the clock 34, and the first to third communication interfaces 35, 36, and 37 are connected by a system bus 38. The system bus 38 includes an address bus and a data bus. The processor 31, the main memory 32, the auxiliary storage device 33, the clock 34, and the first to third communication interfaces 35, 36, and 37 (may also be collectively referred to as units herein) are connected by the system bus 38 to configure or function as a computer.

In one example, the processor 31 is equivalent to a central part of the computer. The processor 31 controls the units to realize various functions of the coupon server 30 according to an operating system and/or application programs. The processor 31 is, for example, a Central Processing Unit (CPU).

In one example, the main memory 32 is equivalent to a main storage part of the computer. The main memory 32 includes a nonvolatile memory region and a volatile memory region. The main memory 32 stores, in the nonvolatile memory region, the operating system and/or the application programs. The main memory 32 stores, in the volatile memory region, data necessary for the processor 31 to execute various processing for controlling the units. The main memory 32 uses the volatile memory region as a work area in which data is rewritten as appropriate by the processor 31. The nonvolatile memory region is, for example, a Read-Only Memory (ROM). The volatile memory region is, for example, a Random-Access Memory (RAM).

In one example, the auxiliary storage device 33 is equivalent to an auxiliary storage part of the computer. As the auxiliary storage device 33, for example, a single storage device such as an SSD, an HDD, or an EEPROM is used or a plurality of such storage devices are used in combination. The auxiliary storage device 33 saves data to be used by the processor 31 in performing various kinds of processing, data generated by the processing by the processor 31, and the like. The auxiliary storage device 33 may also store the application programs.

The application programs stored by the main memory 32 or the auxiliary storage device 33 include a control program. The control program includes a coupon issuing program and a coupon updating program in the present embodiment. A method of installing the control program in the main memory 32 or the auxiliary storage device 33 is not particularly limited. The control program can be installed in the main memory 32 or the auxiliary storage device 33 by recording the control program in a removable recording medium or distributing the control program by communication via a network. A form of the recording medium may be any form, such as a CD-ROM and a memory card, so long as the recording medium can store a program and can be read by a computer or any other appropriate devices or apparatuses.

The clock 34 functions as a time information source of the coupon server 30. The processor 31 acquires a present date and time based on time information tracked by the clock 34.

The first communication interface 35 performs data communication with the member server 10 using the network among the various servers in the system. The second communication interface 36 performs data communication with the store server 20 via the network. The first communication interface 35 and the second communication interface 36 may be integrated into one communication interface.

The third communication interface 37 connects a communication network 50. The communication network 50 is a wide-area general-purpose network and is configured by one or more networks such as a cellular phone network and the Internet. A plurality of access points 51 capable of performing wireless communication with the terminal 40 are connected to the communication network 50. The terminal 40 can perform wireless communication with any of the access points 51 and acquire data of the electronic coupon provided from the coupon server 30.

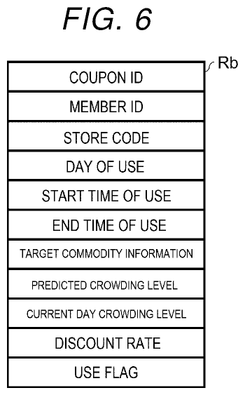

The coupon server 30 uses part of a storage region of the auxiliary storage device 33 as regions of a coupon database 331, a prediction table 332, and a current-day table 333. The coupon database 331 is an aggregate of coupon data records Rb (see FIG. 6) created for respective electronic coupons.

FIG. 6 is a schematic diagram of an example data structure of the coupon data record Rb. The coupon data record Rb includes a coupon ID, a member ID, a store code, a day of use, start time of use, end time of use, target commodity information, a predicted crowding level, a current-day crowding level, a discount rate, and a use flag.

The coupon ID is a unique code that is set for each of the coupon data records Rb to identify each record Rb. The member ID is an identifier of a member to whom the electronic coupon of the coupon data record Rb is provided. The store code is an identifier of a store (a target store) where the electronic coupon of the coupon data record Rb can be used. Specific store codes are respectively set for stores. The day of use, the start time of use, and the end time of use are information for identifying a period of use of the electronic coupon, that is a preset time period during which the electronic coupon can be used. The target commodity information identifies a commodity to which preferential treatment, such as discount, can be granted by the electronic coupon. The target commodity information includes a commodity code and a commodity name of a target commodity. According to the coupon data record Rb, the system of the present embodiment can allow a customer to purchase the target commodity identified by the commodity information and sold at the target store identified by the store code at a price to which the preferential treatment is applied with the electronic coupon within the valid time period from the start time of use to the end time of use on a date set as the day of use.

The predicted crowding level is a degree of crowdedness of the target store for the time period of use (identified in the coupon data record Rb) of the electronic coupon predicted at a point in time when the electronic coupon is provided to the consumer terminal 40. The current-day crowding level is a degree of crowdedness of the target store obtained on a current day during the time period of use of the electronic coupon. The target store is a store where the electronic coupon can be used.

The discount rate is the preferential treatment information of the electronic coupon. The use flag is for identifying whether the electronic coupon corresponding to the coupon data record Rb was used at the target store. In the present embodiment, the use flag is one-bit data representing “unused” as “0” and “used” as “1.”

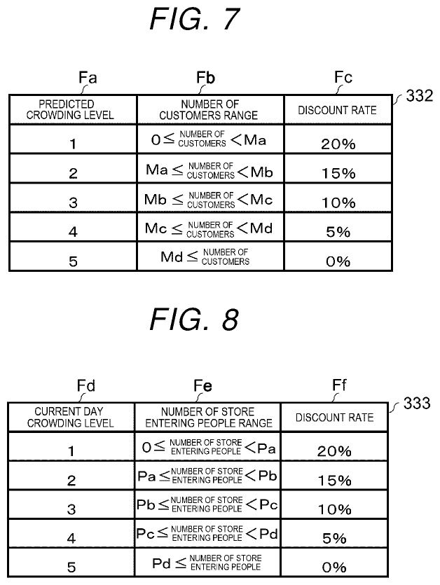

Referring back to FIG. 5, the prediction table 332 stored in the auxiliary storage device 33 of the coupon server 30 is a data table storing data relating to the predicted crowding level. FIG. 7 is a schematic diagram of an example configuration of the prediction table 332. As illustrated in FIG. 7, the prediction table 332 includes a field Fa of the predicted crowding level, a field Fb of a number-of-customers range, and a field Fc of the discount rate.

In the field Fa, the predicted crowding level is described in five stages of “1” to “5” in the present embodiment. The number of stages is not limited to five and can be set to two or more.

In the field Fb, data indicating a range of the number of customers is described for each of the predicted crowding levels. For example, “0≤number of customers<Ma” is described as the number-of-customers range data at the predicted crowding level of 1, “Ma≤number of customers<Ma” is described as the number-of-customers range data at the predicted crowding level of 2, “Mb≤number of customers<Mc” is described as the number-of-customers range data at the predicted crowding level of 3, “Mc≤number of customers<Md” is described as the number-of-customers range data at the predicted crowding level of 4, and “Md≤number of customers” is described as the number-of-customers range data at the predicted crowding level of 5. There is a relation of Ma<Mb<Mc<Md<Me among the numbers of customers Ma, Mb, Mc, Md, and Me. That is, the predicted crowding level increases stepwise as the number of customers increases.

In the field Fc, the discount rate is described for each of the predicted crowding level. For example, “20%” is described as the discount rate at the predicted crowding level of 1, “15%” is described as the discount rate at the predicted crowding level of 2, “10%” is described as the discount rate at the predicted crowding level of 3, “5%” is described as the discount rate at the predicted crowding level of 4, and “0%” is described as the discount rate at the predicted crowding level 5. That is, the lower the predicted crowding level is, the higher the discount rate is. Values of the discount rate are not limited to this example. The same discount rate including 0% may be set for different predicted crowding levels.

The numbers of customers in the prediction table 332 coincide with the numbers of customers for the respective time periods MOa, MOb, . . . and SUf stored in the number-of-customers memory 21 of the store server 20. Therefore, a smaller number of customers that is a lower predicted crowding level in the prediction table 332 indicates a time period in which the number of visitors was smaller in the past. In the present embodiment, an electronic coupon valid and usable in a time period in which the number of visitors is predicted to be small or smaller will be provided to a consumer. Moreover, the smaller the predicted number of visitors is for a specific time period, the higher the discount rate of the electronic coupon is for that time period. This makes the number of customers visiting the store in order to use the electronic coupon with the higher discount rate increase during the specific time period in which the number of visitors is predicted to be small or smaller. Also, the rate of the increase (change) is assumed to increase as the number of visitors decreases.

Referring back to FIG. 5, the current-day table 333 stored in the auxiliary storage device 33 of the coupon server 30 is a data table in which data relating to the current-day crowding level is stored. FIG. 8 is a schematic diagram of an example configuration of the current-day table 333. As illustrated in FIG. 8, the current-day table 333 includes a field Fd of the current-day crowding level, a field Fe of a number-of-store-entering-people range, and a field Ff of the discount rate.

In the field Fd, the current-day crowding level is described in five stages of “1” to “5” in the present embodiment. The number of stages of the current-day crowding level is not limited to five, but it needs to be the same as the number of stages of the predicted crowding level in the prediction table 332.

In the field Fe, data indicating a range of the number of store-entering people is described. For example, “0≤number of store entering people<Pa” is described as the number-of-store-entering-people range data at the current-day crowding level of 1, “Pa≤number of store entering people<Pb” is described as the number-of-store-entering-people range data at the current-day crowding level of 2, “Pb≤number of store entering people<Pc” is described as the number-of-store-entering-people range data at the current-day crowding level of 3, “Pc≤number of store entering people<Pd” is described as the number-of-store-entering-people range data at the current-day crowding level of 4, and “Pd≤number of store entering people” is described as the number-of-store-entering-people range data at the current-day crowding level of 5. There is a relation of Pa<Pa<Pc<Pd<Pe among the numbers of store-entering people Pa, Pb, Pc, Pd, and Pe. That is, the current-day crowding level increases stepwise as the number of store-entering people increases.

In the field Ff, the discount rate is described. For example, “20%” is described as the discount rate at the current-day crowding level of 1, “15%” is described as the discount rate at the current-day crowding level of 2, “10%” is described as the discount rate at the current-day crowding level of 3, “5%” is described as the discount rate at the current-day crowding level of 4, and “0%” is described as the discount rate at the current-day crowding level 5. That is, the lower the current-day crowding level is, the higher the discount rate is. Values of the discount rate are not limited to this example. The same discount rate including 0% may be set for different current-day crowding levels. However, the discount rate of a specific current-day crowding level needs to be the same as that of the same predicted crowding level in the prediction table 332.

The number of store-entering people is equivalent to the number of store-entering people Ns stored in the current-day memory 22 of the store server 20. Therefore, a smaller number of store-entering people that corresponds to a lower current-day crowding level in the current-day table 333 indicates that the store is not crowded at the present point in time. In the present embodiment, if the current-day crowding level is lower than the predicted crowding level, that is, if the store is less crowded on the current day (or at the present point in time) than predicted, the discount rate of the already-provided (or already-issued) electronic coupon valid and usable on the current day is updated to be higher. Therefore, even if the number of visitors on the current day is smaller than predicted, meaning that there are less visitors to the target store on that specific day and time than anticipated with the initial discount rate, more consumers will likely visit the target store during the time period in which the electronic coupon offering the higher discount rate can be used. Consequently, such timely update depending on the current crowdedness at the target store can further the promotion of store visits during much less busy periods and enhance the leveling of the number of store visitors in a more active and effective manner.

Referring FIG. 5 again, the processor 31 of the coupon server 30 includes a function of a coupon issuing unit 311 and a function of a coupon updating unit 312. The function of the coupon issuing unit 311 is realized by the processor 31 performing information processing according to the coupon issuing program as part of the control program. The function of the coupon updating unit 312 is realized by the processor 31 performing information processing according to the coupon updating program as part of the control program.

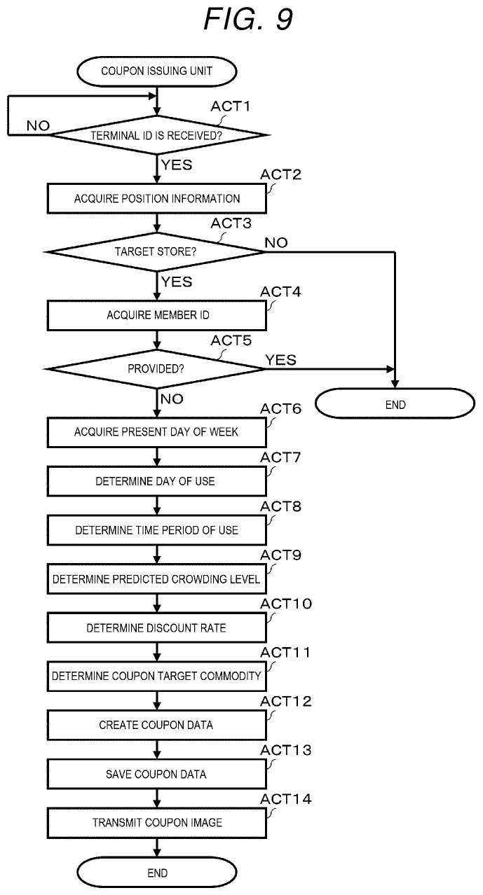

FIG. 9 is a flowchart of an example procedure of the information processing executed by the processor 31 according to the coupon issuing program. The procedure can be changed as appropriate so long as the same or substantially the same effects can be achieved.

First, in ACT 1, the processor 31 waits for a terminal ID to be received. If a consumer carrying the terminal 40 installed with the coupon application enters a wireless communication region of any of the access points 51 (see FIG. 5), a wireless communication line will be established between the terminal 40 and the third communication interface 37 of the coupon server 30. If the communication line is established, the terminal ID is transmitted from the terminal 40 to the coupon server 30 via the third communication interface 37 (YES in ACT 1), and the processor 31 proceeds to ACT 2.

In ACT 2, the processor 31 acquires position information of the terminal 40. For example, the processor 31 acquires, as the position information of the terminal 40, position information of the access point 51 having the communication line established with the terminal 40. If the terminal 40 has a GPS function, the processor 31 may acquire the position information of the terminal 40 from GPS information of the terminal 40.

In ACT 3, the processor 31 confirms whether the terminal 40 is located in a site of a target store. In the coupon server 30, a store-position-information group indicating the site of the target store is preset. If the position information of the terminal 40 is included in the store-position-information group, the processor 31 recognizes that the terminal 40 is located in the site of the target store. The store-position-information group may be set in the store server 20 instead of or in addition to the coupon server 30.

If the terminal 40 is not located in the site of the target store (NO in ACT 3), the processor 31 disconnects the communication line with the terminal 40 and ends the information processing.

If the terminal 40 is located in the site of the target store (YES in ACT 3), the processor 31 proceeds to ACT 4. In ACT 4, the processor 31 acquires a member ID. If a member ID is set in the terminal 40, the processor 31 acquires the member ID from the terminal 40. If a member ID is correlated with the terminal ID and set in the member server 10, the processor 31 acquires the member ID correlated with the terminal ID from the member server 10.

In ACT 5, after the acquisition of the member ID, the processor 31 confirms whether a usable electronic coupon has been provided to the member identified by the member ID. For example, the processor 31 searches through the coupon database 331 (see FIG. 5) and confirms presence or absence of the coupon data record Rb (see FIG. 6) that corresponds to the acquired member ID and that has the preset time period of use (that is identified by the day of use, start time of use and end time of use data) being later than the present date and time tracked by the clock 34. If the relevant coupon data record Rb is present, the processor 31 recognizes that the valid electronic coupon has already been provided to the identified member or the terminal 40 of the identified member (YES in ACT 5). The processor 31 then disconnects the communication line with the terminal 40 and ends the information processing of the coupon issue.

If the relevant coupon data record Rb is absent, the processor 31 determines that the valid electronic coupon has not yet been provided to the identified member (NO in ACT 5) and proceeds to ACT 6 to create a new coupon data record Rb of the electronic coupon targeting the identified member.

In ACT 6, the processor 31 acquires the day of week (from Monday to Sunday, for example) of the present date from the clock 34. In ACT 7, the processor 31 determines the day of use of the electronic coupon. For example, if the valid electronic coupon is scheduled to be issued on the next day of the present day, the processor 31 sets the next day as the day of use for that electronic coupon.

In ACT 8, the processor 31 determines the time period of use of the electronic coupon. For example, the processor 31 acquires, from the store server 20, the number-of-customers memory 21 (see FIG. 3) of the target store where the terminal 40 of the identified member is located. The processor 31 then searches through the number-of-customers memory 21 and determines, as the time period of use, the time period in which the number of customers is the smallest among the stored numbers of customers MOa, MOb, . . . , SUf of the respective time periods of the day of week corresponding to the determined day of use in ACT 7.

If there are multiple time periods that have the smallest number of customers on the determined day of week, the processor 31 may determine the time period of use according to a predetermined rule. For example, the processor 31 selects the earliest time period or the latest time period among such multiple time periods as the time period of use. The predetermined rule for determining or selecting the time period of use is not limited to this example.

In ACT 9, the processor 31 determines a predicted crowding level of the determined time period of use. For example, the processor 31 refers to the prediction table 332 (see FIG. 7) with the number of customers of the determined time period of use. The processor 31 then determines the predicted crowding level corresponding to the number-of-customers range that includes the number of customers of the determined time period of use. For example, if the number of customers of the determined time period of use retrieved from the number-of-customers memory 21 is equal to or larger than Mb and smaller than Mc, that is in the range of Mb≤number of customers<Mc, “3” is determined as the predicted crowding level. If the number of customers of the determined time period of use is equal to or larger than Ma and smaller than Mb, that is in the range of Ma≤number of customers<Mb, “2” is determined as the predicted crowding level.

In ACT 10, the processor 31 determines a discount rate of the electronic coupon. For example, the processor 31 again refers to the prediction table 332 and determines the discount rate corresponding to the predicted crowding level. For example, if the predicted crowding level determined in ACT 9 is 3, the discount rate will be 10%. If the predicted crowding level determined in ACT 9 is 2, the discount rate will be 15%.

In ACT 11, the processor 31 determines a coupon target commodity. For example, the processor 31 inquires the member server 10 about the coupon target commodity using the member ID as a search key. Upon receipt of the inquiry, the member server 10 derives and identifies, based on the member registration information and/or the purchase history information in the member record Ra (see FIG. 2) that corresponds to the member ID used as the search key, a commodity that is likely to be purchased by the member identified by the member ID in the target store and answers the coupon server 30 with the identified commodity. The processor 31 then determines the identified commodity as the coupon target commodity. The commodity likely to be purchased by the identified member is, for example, a commodity with a greater number of sold items, a commodity with a greater sales amount, or a favorite commodity.

In ACT 12, the processor 31 creates the new coupon data record Rb. The coupon ID of the coupon data record Rb is optional. The member ID is the one acquired in the processing in ACT 4. The store code is that code of the target store identified in the processing in ACT 2 and ACT 3. The day of use is the one determined in the processing in ACT 7. The start time of use and the end time of use are those of the time period of use determined in the processing in ACT 8. The predicted crowding level is the one determined in the processing in ACT 9. The current-day crowding level has not been set yet. It will be set at a later timing. The discount rate is the one determined in the processing in ACT 10. The use flag is “0” indicating “unused” since the record RB being created in the processing of ACT 12 is a new record which has not yet been provide to or used by the identified member.

In ACT 13, the processor 31 saves the created new coupon data record Rb in the coupon database 331. In ACT 14, the processor 31 creates image data of the electronic coupon based on the new coupon data record Rb. The processor 31 transmits the image data of the electronic coupon to the terminal 40 of the identified member with which the communication line has been established. Then, the processor 31 disconnects the communication line with the terminal 40 and ends the coupon issue processing.

The processor 31 functioning as the coupon issuing unit 311 executes the processing in ACT 7 to ACT 10 and constitutes a determining unit. That is, the processor 31 determines the period of use and contents (including target commodity information, a discount rate, and the like) of the preferential treatment information (such as the electronic coupon) based on the number of visitors in the past. The period of use is the period during which the store visit is being promoted by the present system.

The processor 31 executes the processing in ACT 14 in cooperation with the third communication interface 37 and constitutes a transmitting unit. That is, the processor 31 transmits the preferential treatment information having the period of use and the contents determined by the determining unit to the terminal 40.

The processor 31 executes the processing in ACT 12 and ACT 13 in cooperation with the auxiliary storage device 33 and constitutes a storing unit. That is, the processor 31 stores, in the coupon database 331, the preferential treatment information transmitted to the terminal 40 by the transmitting unit.

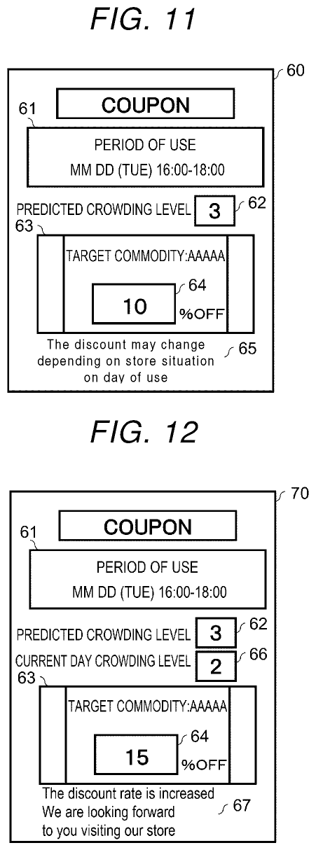

In this way, the processor 31 functions as the coupon issuing unit 311. Consequently, the intended effects can be achieved. That is, if a member, who has not yet received an electronic coupon with an unexpired period of use, enters a site of a target store, image data of the electronic coupon is transmitted from the coupon server 30 to the terminal 40 of the member. As a result, the electronic coupon, such as the one illustrated in FIG. 11, is displayed on a screen of the terminal 40.

FIG. 11 is an example of the electronic coupon 60 being displayed on the terminal 40. As illustrated in FIG. 11, the electronic coupon 60 includes boxes 61, 62, 63 and 64 for the period of use (or the time period of use), the predicted crowding level, and the preferential treatment information, respectively, that are specified in the coupon data record Rb. In the example, the day of use, the start time of use, and the end time of use “MMDD(TUE) 16:00-18:00” are displayed in the box 61 as the time period of use. The predicted crowding level is displayed in the box 62. The target commodity information “AAAAA” is displayed in the box 63 as part of the preferential treatment information. The discount rate “10% OFF” is displayed in the box 64 as another part of the preferential treatment information. Further, a message 65 indicating that the discount rate may change depending on a situation, such as a real-time crowdedness, on a current day of use is included in the electronic coupon 60.

Therefore, by viewing the electronic coupon 60 displayed on the terminal 40, the member, who has been identified with the acquired member ID during the coupon issuing processing shown in FIG. 9, recognizes that he or she can receive the preferential treatment of 10% discount if the target commodity AAAAA is purchased between 16:00 and 18:00 on MM/DD. Moreover, the member can learn that the predicted crowding level for that specific time period, that is the promoted time period, at the target store is “3” indicating that the store is relatively less crowded. As a result, it can be expected that a greater number of members go shopping to the target store during the promoted time period to use the coupon.

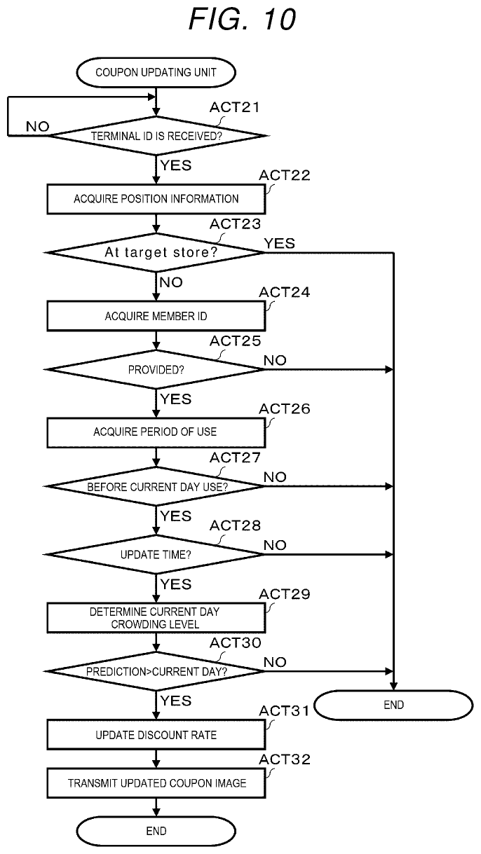

FIG. 10 is a flowchart of an example procedure of information processing executed by the processor 31 according to the coupon updating program. The procedure can be changed as appropriate if the same or substantially the same effects can be achieved.

First, in ACT 21, the processor 31 waits for a terminal ID to be received from the terminal 40. In a similar manner to ACT 1, upon receipt of the terminal ID by the third communication interface 37 (YES in ACT 21), the processor 31 proceeds to ACT 22 and ACT 23.

In a similar manner to ACT 2 and ACT 3, in ACT 22 and ACT 23, the processor 31 acquires position information of the terminal 40 and checks whether the terminal 40 is presently at the target store or not. However, in this instance, if the terminal 40 is at the target store (YES in ACT 23), the processor 31 ends the communication with the terminal 40 and ends the information processing.

If the terminal 40 is not presently at the target store (NO in ACT 23), the processor 31 proceeds to ACT 24. In a similar manner to ACT 4, in ACT 24, the processor 31 attempts to acquire a member ID from the user of the terminal 40. Further, in a similar manner to ACT 5, in ACT 25, the processor 31 confirms whether any valid, usable electronic coupon has already been provided to the member identified by the acquired member ID. If an electronic coupon has not yet been provided (NO in ACT 25), the processor 31 disconnects the communication line with the terminal 40 and ends the information processing since there is no issued coupon to update.

If an electronic coupon has already been provided to the identified member (YES in ACT 25), the processor 31 proceeds to ACT 26. In ACT 26, the processor 31 retrieves the coupon data record RB of the already-provided electronic coupon based on the coupon ID and/or the member ID from the coupon database 331 and acquires the information defining the period of use (a day of use, a start time of use, and an end time of use) from the retrieved coupon data record Rb corresponding to the electronic coupon. In ACT 27, the processor 31 confirms whether the present date as tracked by the clock 34 is the same as the coupon's day of use and whether the present time is before the coupon's start time of use. If the present day is not the day of use or if the present time is after the start time of use (NO in ACT 27), the processor 31 disconnects the communication line with the terminal 40 and ends the information processing.

If the current day is a day of use for the coupon and the present time is before the coupon's start time of use (YES in ACT 27), the processor 31 proceeds to ACT 28. In ACT 28, the processor 31 confirms whether the present time is an update time, that is within a period time before the coupon's start time of use considered acceptable for an update of the coupon's discount amount/rate or the like. For example, if the present time is in a range between one and two hours before the start time of use for the coupon, the processor 31 treats the present time as an update time. If the present time is within some other time period (for example, too close to the start time), the processor 31 treats the present time as not an update time. If the present time is not an update time, the processor 31 determines NO in ACT 28, disconnects the communication line with the terminal 40, ending the information processing.

If the present time is an update time (YES in ACT 28), the processor 31 proceeds to ACT 29. In ACT 29, the processor 31 determines the crowding level being experienced at the store on the current day. Specifically, the processor 31 acquires the store code from the coupon data record Rb and then retrieves, from the corresponding store server 20, the number of store-entering people Ns from the current-day memory 22 (see FIG. 4) of the target store identified by the store code. Next, the processor 31 searches through the current-day table 333 (see FIG. 6) stored in the auxiliary storage device 33 to determine the current-day crowding level for the target store. The processor 31 updates the current-day crowding level in the coupon data record Rb as necessary.

In ACT 30, the processor 31 compares the predicted crowding level and the updated (actual) current-day crowding level in the coupon data record Rb. If the predicted crowding level is equal to or lower than the current day's crowding level (NO in ACT 30), the processor 31 disconnects the communication line with the terminal 40 and ends the information processing.

If the current-day (actual) crowding level is lower than the predicted crowding level (YES in ACT 30), the processor 31 proceeds to ACT 31. In ACT 31, the processor 31 acquires the discount rate corresponding to the current-day crowding level from the current-day table 333. The processor 31 then updates the previous discount rate in the coupon data record Rb to the new discount rate acquired from the current-day table 333.

In ACT 32, the processor 31 also updates the image data of the electronic coupon with the coupon data record Rb to include the updated discount rate. The processor 31 transmits the updated image data for the electronic coupon to the terminal 40 with which the communication line has been established. Then, the processor 31 disconnects the communication line with the terminal 40 and ends the coupon update processing.

The processor 31, functioning as the coupon updating unit 312 in this instance, executes the processing in ACT 26 to ACT 29 thus constitutes an acquiring unit. That is, the processor acquires the number for store-entering people for the current day (when the current day is in the period of use).

The processor 31 executes the processing in ACT 30 and ACT 31 and thus constitutes a changing unit or an updating unit. That is, the processor 31 changes the preferential treatment information (for example, the electronic coupon) provided to the terminal 40 to further promoting store visit when crowding at the store is less than expected/predicted on the day the coupon or the like can be used.

Furthermore, the processor 31 executes the processing in ACT 21 to ACT 23 and ACT 32 and thus constitutes a notifying unit. That is, the processor 31 notifies the change or update of the preferential treatment information to the terminal 40 of a consumer who has not yet visited the target store where the updated preferential treatment is available.

In this way, the processor 31 functions as the coupon updating unit 312. Consequently, the intended effects can be achieved. That is, sometimes, a store's crowding level will be lower than the predicted level and thus the number of visitors is less than predicted. In such a case, the electronic coupon previously provided to encourage store visits during a predicted low crowding period is updated to provide even greater encouragement when the actual crowding level appears likely to be even lower than predicted level. Thus, updated image data for the electronic coupon is transmitted to the terminal 40. As a result, the electronic coupon 60 (FIG. 11) displayed on the screen of the terminal 40 is changed using the updated image data to an updated electronic coupon, such as the one illustrated in FIG. 12.

FIG. 12 is an example of the updated electronic coupon 70 being displayed on the terminal 40. As illustrated in FIG. 12, in the updated electronic coupon 70, a box 66 for the current-day crowding level specified in the updated coupon data record Rb has been added to the electronic coupon 60. In the example, the current-day crowding level “2” is displayed in the box 66. Also, the discount rate has been updated to “15% OFF” in the box 64 according to the updated coupon data record Rb. Further, the previous message 65 included in the electronic coupon 60 has been changed (updated) to a new message 67 notifying that the discount rate has been increased and encouraging the member to visit the store.

Therefore, the member carrying the identified terminal 40 on which the updated electronic coupon is being displayed can recognize that the discount rate has increased from the previous discount rate. Moreover, the member can learn that this increase is because the crowding level of the target store at the present time is lower than predicted. As a result of this further promotion by the timely update of the electronic coupon based on the current crowdedness situation, it can be expected that a more members will visit the target store during the targeted period of use.

As explained above, the coupon server 30 in the present embodiment not only provides the electronic coupon having a particular period of use during which the number of visitors is predicted to be less than other time periods but also increases the discount rate of the electronic coupon if the actual number of store visitors on the current day of the period of use are fewer than expected. Therefore, it is expected at a higher probability that more members will visit the target store to use the updated electronic coupon during that specific time period. Accordingly, the leveling of the number of visitors over store hours at a retail store or the like can be achieved in a more active and effective manner. And, furthermore, it is possible to avoid crowding or a risk of overcrowding in such stores as much as possible from the viewpoint of infectious disease prevention.

While some example embodiments have been explained, the present disclosure is not limited to these embodiments.

For example, the preferential treatment information may not only be an electronic coupon with a discount applicable to a specific target commodity but may also be an electronic coupon with a discount applicable to a subtotal of an entire purchase price. As another example, the preferential treatment information may be for performing preferential treatment through other forms of a discount, a price change, or the like or for preferentially treating a facility use fee or the like.

The electronic coupon can be of two or more types or variations, and such electronic coupons of multiple types may be simultaneously provided to the terminal 40. For example, in the process of ACT 7 in FIG. 9, the processor 31 determines the next day and the day after the next as the days of use, that are the valid days of coupon use. The processor 31 then executes the processes of ACT 8 to ACT 14 for each of the valid days of coupon use. This makes it possible to simultaneously provide the electronic coupons of two types having the different valid days of use to the terminal 40 of the consumer.

As to the electronic coupon 60 illustrated in FIG. 11, if the box 62 is touched through the touch panel of the terminal 40, the data of the prediction table 332 may also be displayed on the terminal 40. This way, a member can easily learn a correspondence relation of the predicted crowding level with the number-of-customers range and the discount rate.

Similarly, if the box 66 of the updated electronic coupon 70 illustrated in FIG. 12 is touched, the data of the current-day table 333 may also be displayed on the terminal 40. This way, a member can easily learn a correspondence relation of the current-day crowding level with the number-of-store-entering-people range and the discount rate.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A preferential treatment information management device, comprising:
a storage device storing preferential treatment information previously provided to a consumer terminal, the preferential information including a period of use during which a visit to a store is being promoted, a predicted store crowding level for the period of use, and a coupon set based on the predicted store crowding level; and
a processor configured to:
acquire the number of people entering the store on a current day that falls within the period of use; and
update the coupon in the stored preferential treatment information according to the acquired number of people entering the store.

2. The preferential treatment information management device according to claim 1, wherein the processor is further configured to send an update of the preferential treatment information to the consumer terminal when the coupon in the stored preferential treatment information is updated.

3. The preferential treatment information management device according to claim 2, wherein the processor sends the update of the preferential treatment information to the consumer terminal prior to a time period in the period of use.

4. The preferential treatment information management device according to claim 1, wherein the processor is further configured to:
set the period of use and the coupon of the preferential treatment information based on a number of visitors to the store in the past.

5. The preferential treatment information management device according to claim 1, wherein
the preferential treatment information includes a discount rate of the coupon, and
the processor updates the discount rate when the coupon in the stored preferential treatment information is updated according to the acquired number of people entering the store.

6. The preferential treatment information management device according to claim 5, wherein the processor sets the discount rate based on a crowding level at the store during the current day.

7. The preferential treatment information management device according to claim 6, wherein the processor increases the discount rate if the crowding level on the current day is lower than the predicted store crowding level.

8. A preferential treatment information management device, comprising:
a storage device configured to store:
a coupon database for coupon data of coupons to be included in preferential treatment information, the coupon data including a designated time period during which the coupon can be used at a target store and a predicted crowding level for the store during the designated time period;
a prediction table including a plurality of crowding levels associated with discount rates; and
a current-day table including a plurality of current-day crowding levels associated with discount rates; and
a processor configured to:
issue the coupon data to a consumer terminal before the designated time period, the coupon data including a first discount rate from the prediction table;
acquire the number of people entering the target store on a current day that falls within the designated time period;
retrieve a second discount rate from the current-day table based on the acquired number of store-entering people; and
update the issued coupon data to include the second discount rate.

9. The preferential treatment information management device according to claim 8, wherein the processor updates the coupon data that has been issued to the terminal before the designated time period.

10. The preferential treatment information management device according to claim 8, wherein the processor updates the issued coupon data if the acquired number of people entering the store on the current day is less than the predicted crowding level.

11. The preferential treatment information management device according to claim 8, wherein the second discount rate is higher than the first discount rate.

12. A non-transitory computer-readable medium storing therein a program which, when executed, causes a computer to perform preferential treatment information managing processing comprising:
storing preferential treatment information previously provided to a consumer terminal, the preferential information including a period of use during which a visit to a store is being promoted, a predicted store crowding level for the period of use, and a coupon set based on the predicted store crowding level;
acquiring the number of people entering the store on a current day if the current day is within the period of use; and
updating the coupon in the preferential treatment information stored in the storage device according to the acquired number of people entering the store.

13. The non-transitory computer-readable medium according to claim 12, wherein the processing further comprises:
sending the update of the preferential treatment information to the consumer terminal.

14. The non-transitory computer-readable medium according to claim 12, wherein the processing further comprises:
updating the coupon that has been issued to the consumer terminal before the period of use.

15. The non-transitory computer-readable medium according to claim 12, wherein the processing further comprises:
setting the period of use and the coupon based on a number of visitors to the store in the past.

16. The non-transitory computer-readable medium according to claim 12, wherein
the preferential treatment information includes a discount rate of the coupon, and
updating the preferential treatment information comprises updating the discount rate.

17. The non-transitory computer-readable medium according to claim 16, wherein the initial discount rate is selected from a table based on historical store crowding levels.

18. The non-transitory computer-readable medium according to claim 17, wherein the updated discount rate is selected from a table based on current day store crowding level.

19. The non-transitory computer-readable medium according to claim 18, wherein the updated discount rate is higher than the initial discount rate when the current day crowding level is lower than the predicted store crowding level.

20. The non-transitory computer-readable medium according to claim 12, wherein the coupon is changed when a current day crowding level is lower than the predicted store crowding level.
